(19) United States
(12) Patent Application Publication
(10) Pub. No.: US 2009/0224031 A1
(43) Pub. Date: Sep. 10, 2009

(54) System Device for Verifying an Electronic Voting Record and Method for the Same

(76) Inventor: Len Simonis, Woodstock, GA (US)

Correspondence Address: Clements Bernard PLLC, 1901 Roxborough Road, Suite 300, Charlotte, NC, 28211, US

(21) Appl. No.: 12/400,232

(22) Filed: Mar. 9, 2009

Related U.S. Application Data
(60) Provisional application No. 61/035,158, filed on Mar. 10, 2008.

(51) Int. Cl. G07C 13/00

(52) U.S. Cl. 235/51; 235/386

(57) ABSTRACT

The present invention provides methods and systems for a vote recording and tabulation system for use with a plurality of electronic voting machines, including a first plurality of voting machine monitors configured with a software system permitting a poll worked to verify software utilized during an election, an independent tabulation system for accepting votes stored on the plurality of electronic voting machines, and a digital signature assigned to each vote cast by the voting machine monitor software running on the electronic voting machine, whereby each vote is downloaded to the independent tabulation system, wherein the independent tabulation system verifies the digital signature assigned to each vote and tabulates the final vote total.

### CROSS REFERENCE TO RELATED PATENT APPLICATION

The current application claims the benefit of the earlier priority filing date of the provisional application, Ser. No. 61/035,158, that was filed on Mar. 10, 2008.

### FIELD OF THE INVENTION

The present invention relates generally to a system and device for verifying an electronic voting record and method for the same, and in particular a system that utilizes a plurality of hand held devices that can verify the software and votes on an electronic voting record and method for the same.

### BACKGROUND OF THE INVENTION

Many states have mandated the use of electronic voting machines. These machines are intended to replace the ubiquitous paper ballot, wherein a voter punches out a chad indicating their vote. The introduction of the electronic voting machine has been met with resistance and uncertainty, as there is a concern as to the validity, security, and safety of these machines. The overwhelming concern with using electronic voting machines is the validity of the results

Many concerns arise based upon the perceived fear that the electronic voting machine might be altered or tampered with, causing an erroneous election result. These concerns are not entirely misplaced. Potential opportunities exist for fraud to occur during the use of electronic voting machines, such as 1) altering the electronic voting record; 2) compromising the voting software, creating an unintended result; and 3) altering the tabulation software, resulting in an erroneous final tabulation.

The present invention is intended to belay these fears by providing a quick, non-intrusive system, device, and method to verify the software on an electronic voting machine and ensure accurate election results.

### BRIEF SUMMARY OF THE INVENTION

A preferred embodiment of the present invention provides a software certification device that includes a voting machine monitor configured with a software system permitting a poll worker to verify software utilized during an election, a snapshot of a certified voting software stored on the voting machine monitor for comparison purposes, and at least one electronic voting machine coupled with the voting machine monitor.

According to one preferred embodiment of the disclosed invention, a cradle recharges the software certification device.

According to another preferred embodiment of the disclosed invention, a reset button is positioned on the voting machine monitor for resetting the software system contained thereon.

According to yet another preferred embodiment of the disclosed invention, a vote recording and tabulation system for use with a plurality of electronic voting machines, including a first plurality of voting machine monitors configured with a software system permitting a poll worked to verify software utilized during an election, an independent tabulation system for accepting votes stored on the plurality of electronic voting machines, and a digital signature assigned to each vote cast by the voting machine monitor software running on the electronic voting machine, whereby each vote is downloaded to the independent tabulation system, wherein the independent tabulation system verifies the digital signature assigned to each vote and tabulates the final vote total.

According to yet another preferred embodiment of the disclosed invention, a vote recording and tabulation system that includes a second plurality of voting machine monitors for scanning each first plurality of voting machine monitors to ensure the first plurality of voting machine monitors have not been tampered with.

According to yet another preferred embodiment of the disclosed invention, a method of certifying an election that includes providing a voting machine monitor, creating a snapshot of the certified voting software on an electronic voting machine, downloading the snapshot to the voting machine monitor, attaching the voting machine monitor to an electronic voting machine, comparing the software on the electronic voting machine to the snapshot downloaded to the voting machine monitor, and displaying a result of the comparison of the software to the snapshot.

According to yet another preferred embodiment of the disclosed invention, a method of certifying an election that includes signing each vote cast by a user on an electronic voting machine using a public key of the voting machine monitor.

According to yet another preferred embodiment of the disclosed invention, a method of certifying an election that includes authenticating the voting machine monitor.

According to yet another preferred embodiment of the disclosed invention, a method of certifying an election that includes exchanging a public and private key pair between the voting machine monitor and the electronic voting machine.

According to yet another preferred embodiment of the disclosed invention, a method of certifying an election that includes communicating with the voting machine monitor via a serial communication protocol.

According to yet another preferred embodiment of the disclosed invention, a method of certifying an election that includes downloading all votes cast on the electronic voting machine into an independent tabulation system, and verifying each votes' digital signature, and tabulating the final votes independent of the election machine vendor's tabulation.

According to yet another preferred embodiment of the disclosed invention, a method of certifying an election, that includes connecting a voting machine monitor to an electronic voting machine that includes sending an identifying number by the voting machine monitor to the electronic voting machine, sending an additional identifying number by the voting machine monitor that is encrypted using a public key of the electronic voting machine monitor, decrypting the encrypted identifying number, sending an identifying number by the electronic voting machine encrypted using the voting machine monitor's public key, decrypting the encrypted identifying number, verification of the voting machine monitor and the electronic voting machine, transmission of the final keys necessary to complete the algorithm, and making a snapshot of the electronic voting machine software.

According to yet another preferred embodiment of the disclosed invention, a method of certifying an election that includes seating the voting machine monitor in a cradle for recharging.

According to yet another preferred embodiment of the disclosed invention, a method of certifying an election that includes depressing a rest button for resetting the software contained on the device.

According to yet another preferred embodiment of the disclosed invention, a method of certifying an election that includes communicating via a serial communication protocol.

According to yet another preferred embodiment of the disclosed invention, a method of certifying an election that includes providing a public private key pair to each voting machine monitor, providing a public private key pair to each electronic voting machine, and transmitting an identifying number to the electronic voting machine by the voting machine monitor.

According to yet another preferred embodiment of the disclosed invention, a method of certifying an election that includes transmitting an identifying number to the voting machine monitor by the electronic voting machine.

According to yet another preferred embodiment of the disclosed invention, a method of certifying an election that includes decrypting the identifying numbers using the private key of the electronic voting machine and voting machine monitor, respectively.

According to yet another preferred embodiment of the disclosed invention, a method of certifying an election that includes verifying the voting machine monitor and electronic voting machine are authentic.

According to yet another preferred embodiment of the disclosed invention, a method of certifying an election that includes transmitting the final keys necessary to complete the algorithm, thus enabling the voting machine monitor software to begin communicating and scanning the electronic voting machine software.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of the device.

FIG. 2 is another perspective view of the device with an optional cradle.

FIG. 3 is a bottom view of the device.

FIG. 4 is another perspective view of the device, exemplifying a not connected message.

FIG. 5 is another perspective view of the device, exemplifying a connected message.

FIG. 6 is another perspective view of the device, exemplifying a no differences found message.

FIG. 7 is another perspective view of the device, exemplifying a warning message.

### DETAILED DESCRIPTION OF THE INVENTION

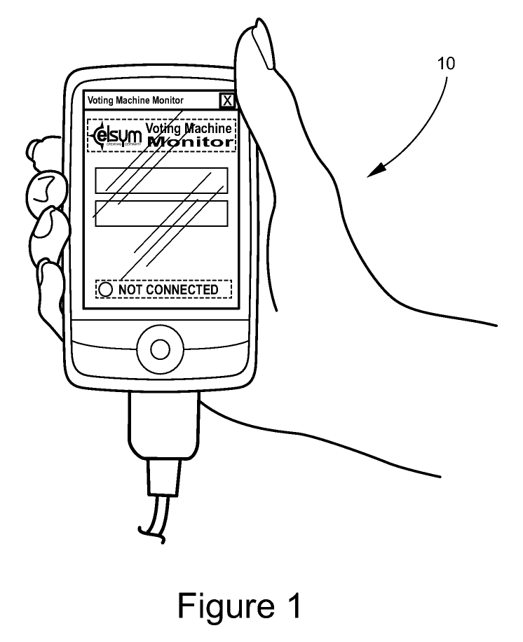

Referring now specifically to the drawings, an exemplary device for verifying an electronic voting record is illustrated in FIG. 1 and is shown generally at reference numeral 10. The device is commonly referred to as a voting machine monitor (VMM) that allows election officials to verify that an electronic voting machine's software and the actual vote recorded on the electronic voting machine have not been tampered with or altered. The VMM 10 can be of any shape and size, but in one exemplary embodiment, the VMM 10 is a handheld device that may be easily transported within the palm of an individual's hand.

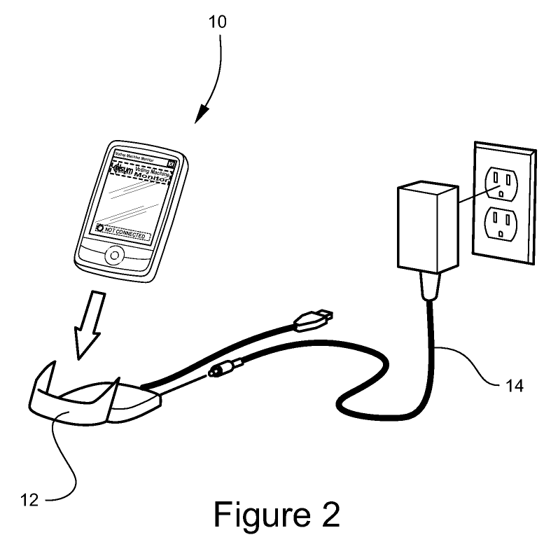

The VMM 10 may also utilize a cradle 12 for receiving the VMM 10 for recharging and storage. An example of a cradle 12 is illustrated in FIG. 2. An electrical cord 14 is connected to the cradle 12 for supplying power and recharging the VMM 10. Depending upon the configuration of the cord 14, one end is inserted into either the female or male end of the cradle 12, while the opposite end is inserted into an external power source, such as a standard electrical outlet. Alternatively, the electrical cord 14 may be inserted into the VMM 10 without the need for the cradle 12. This arrangement allows the battery in the VMM 10 to be recharged without the use of the cradle 12.

In another exemplary embodiment, the cradle 12 may include a power pack or the like that can recharge the VMM 10 without the need for an electrical cord 14 to supply power to the cradle 12. In this embodiment, the cradle 12 may contain rechargeable batteries to supply the appropriate power to the VMM 10, wherein the rechargeable batteries may be recharged with the use of an electrical cord 14. The electrical cord 14 may be inserted into the cradle 12, and another end of the electrical cord 14 may be inserted into an electrical outlet, thus supplying the requisite power to recharge the batteries.

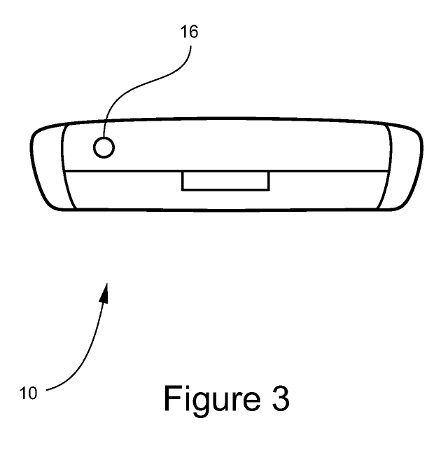

As illustrated in FIG. 3, the VMM 10 contains a recessed reset button 16. The reset button is recessed within the body of the VMM 10 for preventing the accidental resetting of the device. The reset button is recessed within a channel bored into the body of the VMM 10. The channel has a diameter substantially the same size as the head of a safety pin or a ball point pen, allowing the user to insert these articles into the channel to depress the reset button. When the reset button is depressed, the software on the VMM 10 is restarted.

The electronic voting machine described herein may be a direct-recording electronic (DRE) voting machine. Since the DRE is the most prominent electronic voting machine in use today, DRE is used herein out to describe the electronic voting machine. However, the term DRE is not mean to depart from or limit the intent and scope of the disclosed invention. The DRE records votes utilizing a ballet display provided by mechanical or electro-optical components. The components are activated by the user using a touch screen to make the appropriate ballot selection. The DRE stores each vote, and produces a tabulation at the end of the election of the voting data stored therein. The DRE may also print the tabulation as a hard copy.

Prior to the election, it is important to certify that the software on each DRE is the actual and intended certified software, which has been approved by the state voting authority. From a security standpoint, it is extremely important to ensure that the software on each machine is certified, resulting in the machine publishing the correct ballot and tabulating an accurate number of votes cast for a particular candidate. Most states have a mandatory procedure for certifying the software contained on the DRE, allowing the software to be certified by the state itself or an independent testing authority.

The VMM 10 is designed for connection to a typical voting machine for verifying the software operating on the voting machine is certified. The VMM 10 is also designed to record the votes that have been cast on the voting machine to ensure the accuracy of the votes at any time within the span of an election. The VMM 10 may be connected to the voting machine before voting actually begins, during the time period when voting is occurring, after all voting has been completed, or combinations thereof. The VMM 10 is designed for use at any stage in the voting process to verify the software on the voting machine is certified, and to ensure the votes cast by a voter are legitimate, resulting in accurate final tabulations.

The VMM 10 is used to verify that certified software is being utilized during the election. The VMM 10 is wholly separate from the DRE, and is only externally connected to the DRE at the desire of the election worker. The prior art devices utilize an integral verification system, which is inferior to the disclosed invention. The disclosed invention provides for better security because of the physical separation of the VMM and DRE, resulting in the physical separation of specified duties.

A central database and recording system may be utilized to organize and control a plurality of the VMMs during an election. The central database tracks each VMM 10 used during the election, and may track each individual DRE. The central database includes an independent tabulation system (ITS) to accept votes stored on the plurality of DREs, enabling the votes to be independently counted and recorded by the recording system. In one exemplary embodiment, the information stored on the DRE, including the voting races, are loaded and stored on the ITS.

Prior to using the VMM 10, an initialization process is commenced. During the initialization process, each DRE is registered with the VMM's central software database, and each VMM 10 is registered with the central software database as well. Public key cryptography or asymmetric cryptography is utilized to ensure confidentiality. Once the state or an independent testing authority has certified the software on the DRE and possibly the software on the VMM 10, the central system provides a RSA public private key pair to each VMM 10 and a public private key pair to each DRE. The purpose of these keys is to authenticate the DRE and the VMM 10 when the VMM 10 is connected to the DRE during the election process to ensure confidentiality. The DRE receives a DRE private key and a VMM public key, while the VMM 10 receives a VMM private key and a DRE public key.

The keys are utilized to authenticate the DRE and VMM 10 when a connection is made between them. The private key is kept confidential, while the public key may be widely distributed. The keys are related mathematically, but the private key cannot be derived from the public key, resulting in a message encrypted with the public key only being decrypted by a corresponding private key. The DRE also utilizes the VMM public key to record a VMM signature for each vote as it is cast and recorded. The vote may be verified with the public key, proving the authenticity of the signed vote and that the vote has not been tampered with.

Once the DRE software has been certified, a digital snapshot of the certified software is created and downloaded to the VMM central system. The digital snapshot is then loaded onto each VMM 10 for comparing the software on the DRE during the election process to ensure the previously certified software is running on the DRE.

The DRE contains a read only software program that communicates with the VMM 10 using a serial communication protocol. The DRE does not know the full algorithm necessary to enable the VMM 10 to scan the DRE software for making a snapshot of the software. The missing algorithm keys to complete the scan process are not transmitted until after the devices are connected, wherein the software authenticates the legitimacy of the VMM 10, and the VMM 10 authenticates the legitimacy of the DRE. The DRE contains the VMM 10 software enabling a snapshot of the DRE software to be recorded, and the signing of each vote cast by a voter by the VMM 10 for increasing security.

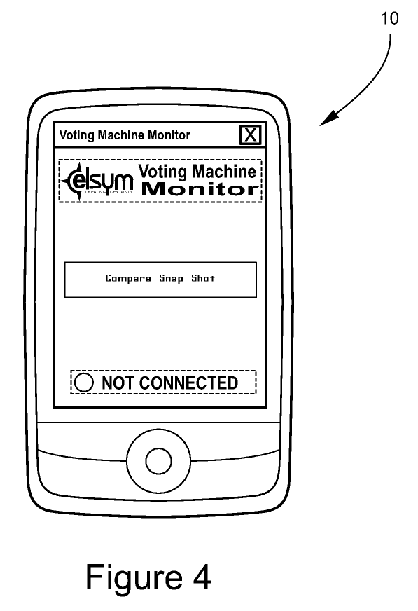

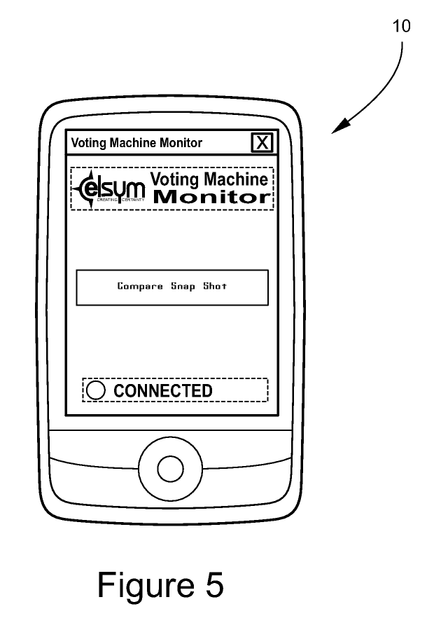

During the election process, a voter casts a ballot for a particular candidate. When the vote is cast, the vote is signed using the VMM's public key and stored on the DRE. Alternatively, the vote may be signed with the VMM's private key. While the DRE software is static and will not change, the VMM's “read only” software program is active, waiting for a connection to be made by a VMM 10. Obviously, the most practical time to connect the VMM 10 to the DRE is when a voter is not actively using the voting machine. For connection, the VMM 10 is connected to the DRE by way of a connection cable or the like. The connection cable may be any suitable method of serial communication, including, but not limited to, DB9, DB25, centronics parallel, USB, PCMCIA, express card, smartcard, or any other similar method of communicating instructions from one device to another. The VMM 10 will produce a message to the user indicating whether or not the VMM 10 is connected to the DRE. For example, when a VMM 10 is not properly connected to the DRE a warning message is displayed, as illustrated in FIG. 4, but when a proper connection is accomplished, an indication message is displayed, as illustrated in FIG. 5.

Once connected, the VMM 10 initially attempts to contact the DRE. If this attempt is successful, meaning there is an active connection between the VMM 10 and DRE, the VMM 10 sends an identifying number that is received by the DRE. In return, the DRE sends its identifying number to the VMM 10. The VMM 10 then transmits another identifying number that is encrypted using the DRE public key, which the DRE decrypts using its private key to verify. Thereafter, the DRE transmits an identifying number that is encrypted using the VMM public key, which the VMM 10 decrypts using its private key to verify. The identifying numbers allow the VMM 10 and DRE to verify and authenticate the other device. When the VMM 10 and DRE have successfully verified and authenticated each other, substantive communication may begin therebetween.

The VMM 10 transmits the last keys that are necessary to complete the algorithm, thus enabling the VMM software on the DRE to begin communicating and scanning the DRE software and capturing a digital snapshot of the software. When the devices are connected, the last keys of the algorithm are sent, thus initiating the scanning process. This arrangement prevents a “false positive” response that could occur if the VMM software on the DRE was replaced. Once the DRE software has been scanned and a complete digital snapshot has been created, the snapshot is encrypted and transmitted to the VMM 10, where the snapshot is decrypted. The VMM 10 compares the newly created snapshot to the certified snapshot that was downloaded to the VMM 10 before the election process was commenced by the state or independent testing authority. After the snapshots are compared, the results are recorded on the VMM 10.

As mentioned above, the VMM's public key signs each vote as it is cast by a voter. The VMM software running on the DRE would utilize the keys to compare the digital signature of each vote to ensure the votes have not been altered subsequent to the vote being cast. The VMM software simply scans for the digital signature that was signed by the public key, and confirms that the digital signature was the signature placed at the time the vote was cast. The results are transmitted back to the VMM 10.

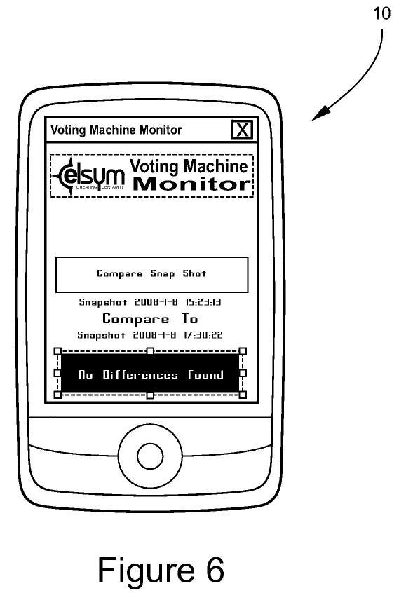

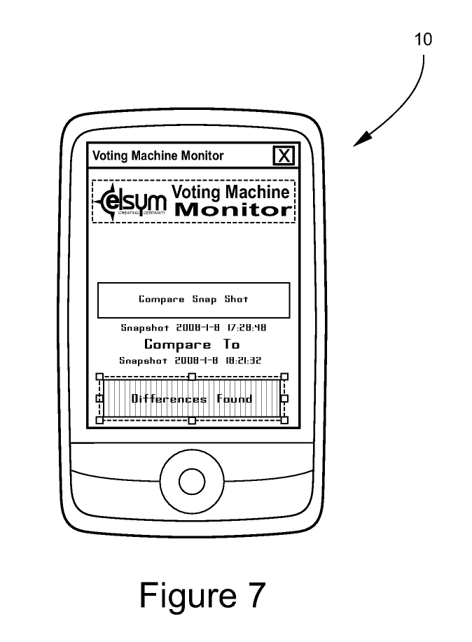

The VMM 10 displays the results of the scanning process in an easy to read format on an LCD screen or the like. The disclosed invention makes the verification process easy to complete by an election poll worker. As illustrated in FIGS. 6 and 7, the displayed results are straight forward and easily understandable by a poll worker. As shown in FIG. 6, if the snapshots compared by the VMM 10 are identical, the VMM 10 displays a result of “No Differences Found” or the like. On the other hand, if the snapshots are not identical, a result) as shown in FIG. 7, is displayed that could consist of a red warning box or the like. If a display as in FIG. 7 is displayed, indicating a problem with the DRE, the voting machine is immediately removed from the election process.

After the polls close and the election is over, each DRE, or the DRE storage device (e.g PCMCIA cards) are transported to an offsite location for vote tabulation. The votes stored on each DRE are downloaded into the election machine vendor's tabulation software system. These votes would also be downloaded into the disclosed invention's ITS. The ITS again verifies each vote's digital signature, and after each signature is verified, the final votes are tabulated. The ITS has the ability to create a set of reports that contain the final vote tabulation, allowing these reports to be compared to the vendor's voting reports for comparison. If a discrepancy occurs, the system will allow for a follow-up electronic review and reconciliation.

To ensure the accuracy of the results, the DRE would be scanned a final time by a set of VMM 10 that have been stored at a central location, away from the various polling locations. The centrally stored VMMs would scan the various DREs as mentioned above. After being scanned this final time, the ITS generates a report of scanning process before the final results of the election may be certified.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A software certification device, comprising:
a voting machine monitor configured with a software system permitting a poll worker to verify software utilized during an election;
a snapshot of a certified voting software stored on the voting machine monitor for comparison purposes; and
at least one electronic voting machine coupled with the voting machine monitor.

2. A software certification device as in claim 1, further comprising a cradle for recharging the software certification device.

3. A software certification device as in claim 1, further comprising a reset button for resetting the software system contained thereon.

4. A vote recording and tabulation system for use with a plurality of electronic voting machines, comprising:
a first plurality of voting machine monitors configured with a software system permitting a poll worked to verify software utilized during an election;
an independent tabulation system for accepting votes stored on the plurality of electronic voting machines;
a digital signature assigned to each vote cast by the voting machine monitor software running on the electronic voting machine;
whereby each vote is downloaded to the independent tabulation system, wherein the independent tabulation system verifies the digital signature assigned to each vote and tabulates the final vote total.

5. A vote recording and tabulation system as in claim 4, further comprising a second plurality of voting machine monitors for scanning each first plurality of voting machine monitors to ensure the first plurality of voting machine monitors have not been tampered with.

6. A method of certifying an election, comprising:
providing a voting machine monitor;
creating a snapshot of the certified voting software on an electronic voting machine;
downloading the snapshot to the voting machine monitor;
attaching the voting machine monitor to an electronic voting machine;
comparing the software on the electronic voting machine to the snapshot downloaded to the voting machine monitor; and
displaying a result of the comparison of the software to the snapshot.

7. A method of claim 6, further comprising signing each vote cast by a user on an electronic voting machine using a public key of the voting machine monitor.

8. A method of claim 6, further comprising authenticating the voting machine monitor.

9. A method of claim 6, further comprising exchanging a public and private key pair between the voting machine monitor and the electronic voting machine.

10. A method of claim 6, further comprising communicating with the voting machine monitor via a serial communication protocol.

11. A method of claim 6, further comprising downloading all votes cast on the electronic voting machine into the independent tabulation system, and verifying each vote's digital signature, and tabulating the final votes independent of the election machine vendors tabulation.

12. A method of certifying an election, comprising:
connecting a voting machine monitor to an electronic voting machine;
sending an identifying number by the voting machine monitor to the electronic voting machine;
sending an additional identifying number by the voting machine monitor that is encrypted using a public key of the electronic voting machine monitor;
decrypting the encrypted identifying number;
sending an identifying number by the electronic voting machine encrypted using the voting machine monitor's public key;
decrypting the encrypted identifying number;
verification of the voting machine monitor and the electronic voting machine;
transmission of the final keys necessary to complete the algorithm; and
making a snapshot of the electronic voting machine software.

13. A method of claim 12, further comprising seating the voting machine monitor in a cradle for recharging.

14. A method of claim 12, further comprising depressing a reset button for resetting the software contained on the device.

15. A method of claim 12, further comprising communicating via a serial communication protocol.

16. A method of communication between a voting machine monitor and an electronic voting machine, comprising:
providing a public private key pair to each voting machine monitor;
providing a public private key pair to each electronic voting machine; and
transmitting an identifying number to the electronic voting machine by the voting machine monitor.

17. A method of claim 16, further comprising transmitting an identifying number to the voting machine monitor by the electronic voting machine.

18. A method of claim 16, further comprising decrypting the identifying numbers using the private key of the electronic voting machine and voting machine monitor, respectively.

19. A method of claim 16, further comprising verifying the voting machine monitor and electronic voting machine are authentic.

20. A method of claim 16, further comprising transmitting the final keys necessary to complete the algorithm thus enabling the voting machine monitor software to begin communicating and scanning the electronic voting machine software.
